(19) United States
(12) Patent Application Publication
(10) Pub. No.: US 2026/0225453 A1
(43) Pub. Date: Aug. 6, 2026

(54) ROAD SURFACE INTERFERENCE DETECTION DEVICE

(71) Applicant: TOYOTA JIDOSHA KABUSHIKI KAISHA, Toyota-shi (JP)

(72) Inventor: Kazuaki KOIDE, Gifu-shi (JP)

(73) Assignee: TOYOTA JIDOSHA KABUSHIKI KAISHA, Toyota-shi (JP)

(21) Appl. No.: 19/439,611

(22) Filed: Jan. 5, 2026

(30) Foreign Application Priority Data
Jan. 31, 2025 (JP) 2025-014915

(51) Int. Cl. B60L 3/00; G01M 3/26

(52) U.S. Cl. CPC B60L 3/0046; G01M 3/26; B60L 2250/10; B60L 2250/16

(57) ABSTRACT

A road surface interference detection device for a vehicle including a battery pack mounted under a vehicle floor, includes a processor configured to determine that the battery pack has come into contact with an obstacle when a cooling function of the battery pack deteriorates within a predetermined time after a proximity sensor detects an abnormality, the proximity sensor being arranged on the vehicle and configured to detect obstacles around the vehicle.

The present application claims priority to and incorporates by reference the entire contents of Japanese Patent Application No. 2025-014915 filed in Japan on January 31, 2025.

### BACKGROUND

The present disclosure relates to a road surface interference detection device.

JP2024083245A discloses a road surface interference sensor including a detection unit arranged below a vehicle's floor panel to detect external forces applied to the vehicle from the road surface. This detection unit includes multiple electrode wires arranged on the inner surfaces of two hollow elastic bodies, detecting external forces based on whether the multiple electrode wires are in contact with each other.

### SUMMARY

JP2024083245A had the problem that a dedicated road surface interference sensor needed to be installed to detect road surface interference, increasing the number of parts.

There is a need for a road surface interference

detection device that may determine object contact using only existing components without increasing the number of parts.

According to one aspect of the present disclosure, there is provided a road surface interference detection device for a vehicle including a battery pack mounted under a vehicle floor, including a processor configured to determine that the battery pack has come into contact with an obstacle when a cooling function of the battery pack deteriorates within a predetermined time after a proximity sensor detects an abnormality, the proximity sensor being arranged on the vehicle and configured to detect obstacles around the vehicle.

### BRIEF DESCRIPTION OF THE DRAWINGS

FIG. 1 is a block diagram showing a functional configuration of a vehicle according to an embodiment of the present disclosure; and

FIG. 2 is a flowchart showing an overview of processing executed by the ECU according to the embodiment of the present disclosure.

### DETAILED DESCRIPTION

A road surface interference detection device according to an embodiment of the present disclosure will now be

described with reference to the drawings. Note that the components in the following embodiment include those that are replaceable and readily available to those skilled in the art, or those that are substantially identical.

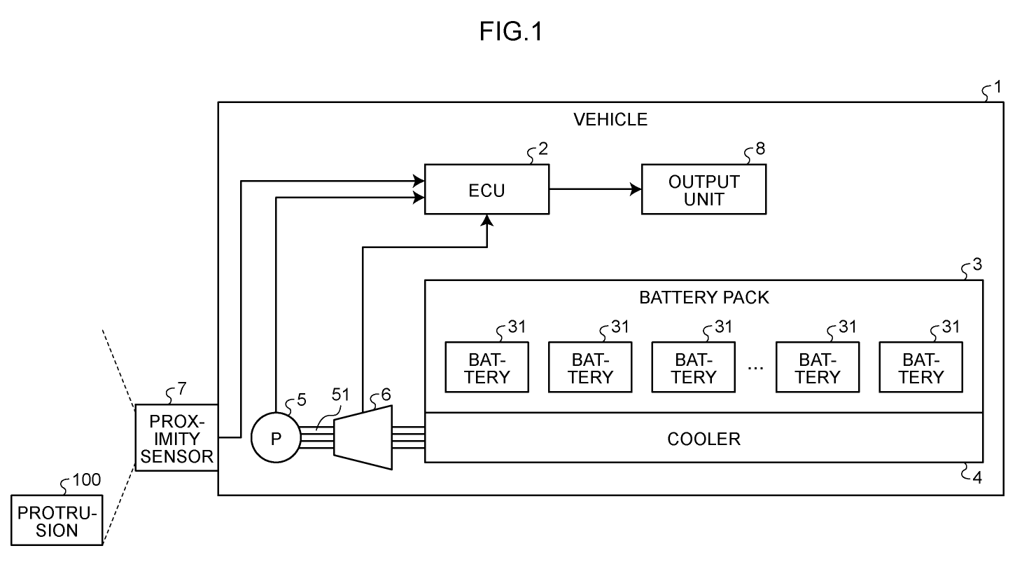

FIG. 1 is a block diagram showing a functional configuration of a vehicle according to an embodiment. The vehicle 1 illustrated in FIG. 1 includes an electronic control unit (ECU) 2, a battery pack 3, a cooler 4, a pump 5, a flow sensor 6, a proximity sensor 7, and an output unit 8.

The ECU 2 is realized by a processor, such as a central processing unit (CPU), and a memory (main storage unit) including a random-access memory (RAM) and a read-only memory (ROM). The ECU 2 determines that battery pack 3 has come into contact with an obstacle or protrusion 100 if the cooling function of the battery pack 3 deteriorates within a predetermined time, e.g., within 5 minutes, after the proximity sensor 7, positioned on vehicle 1 to detect obstacles around vehicle 1, detects an abnormality. Specifically, the ECU 2 acquires flow information regarding the refrigerant flow rate from the flow rate sensor 6, which detects the refrigerant flow rate to the cooler 4 cooling the battery pack 3. Based on this flow information, the ECU 2 determines that the cooling function of the battery pack 3 has decreased if the refrigerant flow rate to the cooler 4 is below a threshold. In the embodiment, the ECU 2 functions as a road surface interference detection device.

The battery pack 3 includes a plurality of batteries 31 housed within a casing. Each of the plurality of batteries 31 is configured as a rechargeable secondary battery, such as a nickel-metal hydride battery or a lithium-ion battery. Each of the plurality of batteries 31 may also be configured as a battery pack including a plurality of single batteries (battery cells), such as lithium-ion batteries, electrically connected in series. Furthermore, each of the multiple batteries 31 may be a battery having a liquid electrolyte between its positive and negative electrodes, or it may be an all-solid-state battery having a solid electrolyte. Each of the multiple batteries 31 supplies power to various parts constituting the vehicle 1, such as motors.

The cooler 4 cools each of the multiple batteries 31 housed within the battery pack 3. The cooler 4 is formed with a waterway (flow path) inside for a coolant to flow through to cool the batteries 31. The cooler 4 is arranged in contact with the battery pack 3. Here, the coolant is, for example, water or ethylene glycol.

The pump 5 circulates refrigerant to the cooler 4 via the refrigerant pipe 51 under control of the ECU 2. A compressor and heat exchanger are arranged between the refrigerant pipe 51 connecting the pump 5 and the cooler 4.

The flow sensor 6 detects the flow rate of the refrigerant supplied to the cooler 4 and outputs this detection result to the ECU 2.

The proximity sensor 7 is configured using an accelerometer, camera, 3D LiDAR, and millimeter-wave sensor, and is positioned in front of the vehicle 1. The proximity sensor 7 detects obstacles such as protrusions 100 or curbs located in front of the vehicle 1 and outputs this detection result to the ECU 2. Here, the protrusions 100 may include not only curbs but also stones, steps, and other obstacles.

The output unit 8 is configured using, for example, a liquid crystal display (LCD), an organic EL display (OLED), a speaker, etc., and outputs various information under the control of the ECU 2.

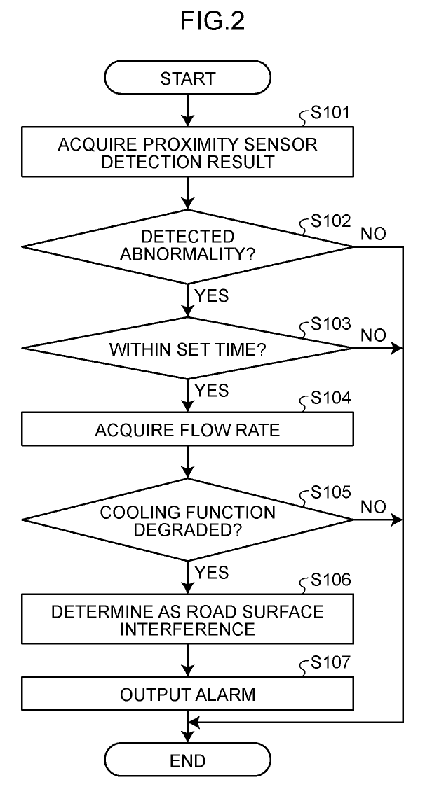

Next, the processing performed by the ECU 2 is described. FIG. 2 is a flowchart showing an overview of the processing executed by the ECU 2.

As illustrated in FIG. 2, the ECU 2 acquires the detection result detected by proximity the sensor 7 (Step S101) and determines whether the proximity sensor 7 detected the protrusion 100 (Step S102). If the proximity sensor 7 detected the protrusion 100 (Step S102: Yes), the ECU 2 proceeds to Step S103. Conversely, if the proximity sensor 7 did not detect the protrusion 100 (Step S102: No), the ECU 2 terminates this processing.

In step S103, the ECU 2 determines whether a predetermined time has elapsed since the proximity sensor 7 detected the protrusion 100. If it determines that the time since the proximity sensor 7 detected the protrusion 100 is within the set time (Step S103: Yes), the ECU 2 acquires the flow rate of the refrigerant supplied from the flow sensor 6 to the cooler 4 (flow rate information) (Step S104). After Step S104, the ECU 2 proceeds to Step S105. Conversely, if the proximity sensor 7 determines that the time since detecting the protrusion 100 is not within the set time (Step S103: No), the ECU 2 terminates this process.

In Step S105, the ECU 2 determines whether the cooling function of the cooler 4 has degraded based on the flow rate (flow rate information) acquired from the flow rate sensor 6. For example, the ECU 2 determines whether the flow rate obtained from the flow sensor 6 is below a threshold indicating that the refrigerant has leaked out due to damage, such as the refrigerant pipe 51 contacting an obstruction like the protrusion 100. In this case, if the flow rate obtained from the flow sensor 6 is below the threshold, the ECU 2 determines whether the cooling function of the cooler 4 has decreased. Conversely, if the flow rate obtained from the flow sensor 6 is not below the threshold, the ECU 2 determines that the cooling function of the cooler 4 has not decreased. If it is determined that the cooling function of the cooler 4 has decreased (Step S105: Yes), the ECU 2 proceeds to Step S106. Conversely, if it is determined that the cooling function of the cooler 4 has not decreased (Step S105: No), the ECU 2 terminates this process.

In step S106, the ECU 2 determines that the bottom surface of the battery pack 3 has come into contact with an obstacle such as an interference object, indicating road surface interference.

Subsequently, the ECU 2 outputs an alarm indicating that the bottom surface of the battery pack 3 has come into contact with an obstacle such as an interference object to the output unit 8 (step S107). Specifically, by outputting an alarm indicating contact between the bottom surface of the battery pack 3 and an obstacle such as an interference object to the output unit 8, the ECU 2 may ensure thorough prompting of the vehicle 1 user for inspection and may also prompt the user for fail-safe operation after the alarm. After step S107, the ECU 2 terminates this process.

According to the above-described embodiment, when the ECU 2 determines that the cooling function of the cooler 4 is impaired, it judges that the battery pack 3 has come into contact with a protruding object 100 such as an obstacle. This allows detection of object contact using only the existing configuration, without increasing the number of parts.

Furthermore, according to the embodiment, when the flow rate obtained by the ECU 2 from the flow sensor 6 is below a threshold, it determines that the battery pack 3 has contacted an obstacle or protrusion 100. This allows object contact to be determined using only the existing configuration without increasing the number of parts.

Furthermore, according to the embodiment, by having the ECU 2 output an alarm to the output unit 8 indicating that the bottom surface of the battery pack 3 has come into contact with an obstacle such as an interference object, it is possible to thoroughly prompt the vehicle 1 user to perform an inspection and also prompt the user to implement fail-safe measures after the alarm.

According to the present disclosure, the effect is achieved of being able to determine contact with an object using only the existing configuration, without increasing the number of parts.

Further effects and variations may be readily derived by those skilled in the art. The broader aspects of the present disclosure are not limited to the specific details and representative embodiment described and illustrated above. Therefore, various modifications are possible without departing from the spirit or scope of the general concept of the disclosure as defined by the appended claims and their equivalents.

The embodiment of the present disclosure has been described in detail above with reference to the drawings. These are merely examples, and the disclosure may be practiced in other forms, including various modifications and improvements based on the knowledge of those skilled in the art, starting with the modes described in the disclosure of the present disclosure.

What is claimed is:

1. A road surface interference detection device for a vehicle including a battery pack mounted under a vehicle floor, comprising
a processor configured to
determine that the battery pack has come into contact with an obstacle when a cooling function of the battery pack deteriorates within a predetermined time after a proximity sensor detects an abnormality, the proximity sensor being arranged on the vehicle and configured to detect obstacles around the vehicle.

2. The road surface interference detection device according to claim 1, wherein the processor is configured to
acquire flow information regarding a flow rate from a flow sensor configured to detect the flow rate of refrigerant to a cooler configured to cool the battery pack, and
determine, based on the flow information, that the cooling function of the battery pack has decreased when the flow rate is below a threshold.

3. The road surface interference detection device according to claim 1, wherein the processor is configured to output an alarm indicating that the battery pack has come into contact with the obstacle when the processor has determined that the battery pack has come into contact with the obstacle.
